(19) United States
(12) Patent Application Publication
(10) Pub. No.: US 2008/0294486 A1
(43) Pub. Date: Nov. 27, 2008

(54) METHOD FOR SUBSTITUTION OF EMPLOYEES IN A SERVICE ENGAGEMENT

(76) Inventors: Daniel Patrick Connors, Pleasant Valley, NY (US); John Peter Fasano, Briarcliff Manor, NY (US); Donna Leigh Gresh, Cortlandt Manor, NY (US)

Correspondence Address: Whitham, Curtis, & Christofferson, P.C.;Suite 340, 11491 Sunset Hills Road, Reston, VA, 20190, US

(21) Appl. No.: 12/051,960

(22) Filed: Mar. 20, 2008

Related U.S. Application Data
(63) Continuation of application No. 11/198,311, filed on Aug. 8, 2005.

(51) Int. Cl. G06Q 10/00

(52) U.S. Cl. 705/8

(57) ABSTRACT

The substitution of employees in a service engagement is a computer based method designed to consider a set of attributes that describe the resource capabilities required for delivering a services engagement and identify the actual real-world human assets that can be substituted and/or matched to these attributes. The method will produce an allocation plan that provides the set of permissible substitutes for a given resource demand, given a set of allowable substitute resources for a particular resource attribute, and substitution and matching rules for the given resource demand. A set of metrics is created that identify which substitutions are best relative to the ideal match of resources to the demand.

### BACKGROUND OF THE INVENTION

1. Field of the Invention

The present invention generally relates to a method for allocating human resources to meet the requirements of a service engagement and, more particularly, to the definition and weighting of capability attributes to identify the best match of available human resources for a given service delivery strategy.

2. Background Description

Companies involved in providing services need to define their staffing requirements over a life cycle of services offerings. For this application, the term “services offering” consists primarily of the application of labor resources to perform a project or implement a service for a customer. For example, a services organization may be contracted to implement a call center for a customer. Implementation of this call center may require different skills sets for various tasks and phases of the implementation. Understanding the labor resource requirements over the short, medium and/or long term allows the companies (e.g., service providers) to plan hiring, transfer or retraining activities to meet expected demand without having an excess supply of personnel.

The requirement of labor resources is different from the requirement for a physical part in a manufactured product. One difference is that, typically, demand for labor resources is more flexible than the demand for a particular part number or subassembly of a manufactured product. The labor resource requirements for the delivery of services offerings usually are defined as skills and/or attributes needed to implement the services offering.

For example, a service offering may specify a need for a Database Architect with DB2™ experience with skill level 8, of category regular employee in the geographic region metropolitan New York. The attributes listed here (i.e., skill level, category, geographic region) are provided as an example and are not intended to limit the invention to only these attributes. One knowledgeable in the art would recognize that numerous other attributes could be used. In addition, some of these attributes may have preferences but may allow for flexibility such as DB2™ experience is desirable but Oracle™ experience may be acceptable if the DB2™ experience is not available. Therefore, when planning the allocation of labor resources to such service engagements many different resources may be acceptable for a particular demand because of this flexibility.

In order to take advantage of this flexibility, it is necessary to present the allowable resources which can be applied to a given resource request or demand. The selection of the most appropriate resource would include the designation of the resource with some metric of ‘suitability’ such that the most suitable available resource would be matched to the demand. The suitability metric would allow second-choice and subsequent choices to be made based on these suitability metrics for each characteristic and/or attribute. The relative ‘goodness’ of a match and/or substitution would be defined by the metric.

### SUMMARY OF THE INVENTION

An exemplary embodiment of the present invention provides a method for determining a set of permissible supplies for a given resource demand.

It is another exemplary embodiment of the invention to perform an analysis of the set of attributes against selection parameters to include substitution or match criteria in order to provide a recommendation for substitution of human resources for a service engagement.

According to the invention, there is provided a computer based method designed to consider a set of attributes that describe the resource capabilities required for delivering a services engagement and identify the actual real-world human assets that can be substituted and/or matched to these attributes. The goal of the invention is to produce an allocation plan that provides the set of permissible substitutes for a given resource demand, given a set of allowable substitute resources for a particular resource attribute, and substitution and matching rules for the given resource demand. This set may be in the form of a listing of acceptable substitutes and may also include but not be limited to a detailed description of the substitution rules.

### BRIEF DESCRIPTION OF THE DRAWINGS

The foregoing and other objects, aspects and advantages will be better understood from the following detailed description of a single embodiment of the invention with reference to the drawings, in which:

FIG. 1 is a block diagram depicting the types of inputs and outputs for the employee substitution method.

FIG. 2 provides a flowchart of the steps for implementing the employee substitution method.

### DETAILED DESCRIPTION OF THE PREFERRED EMBODIMENTS OF THE INVENTION

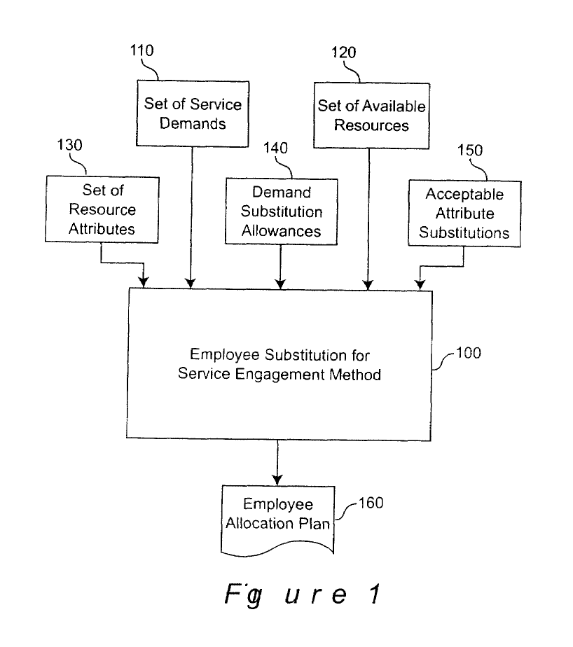

Referring now to the drawings, and more particularly to FIG. 1, there is shown a block diagram of some of the inputs and outputs for the Employee for Substitution Service Engagement Method 100. In order to deliver a service engagement, human assets are required to satisfy a service demand. A demand, for the purposes of this invention, is a required capability or skill. For example, a service engagement to implement a call center operation would require one project manager, two system architects and 25 C++ programmers. These demands could be further characterized by additional attributes such as, skill level, geography, etc. The set of demands 110 for this service engagement would then be one project manager, two system architects and 25 C++ programmers. In order to meet these demands, the services organization would draw from a set of available resources 120.

These resources would consist of the actual human assets available to perform the service. Each available resource could be described by a set of resource attributes 130. For example, job role, skill level, geographic location, language spoken, etc. Unfortunately, the services organization may have only 20 programmers with the job role attribute of “C++ experience.” The service organization would have to hire more programmers with C++ experience or substitute some programmers with other values for the job role attribute that might be acceptable, though not ideal. That is, the service engagement may want 25 programmers with C++ experience; however, it may be acceptable to include 5 JAVA programmers to perform some of the functions of the C++ programmers. This means the service engagement would have acceptable attribute substitutions 150 data that would define what attribute values may be used as substitutes for other attribute values.

Once the acceptable allowances have been determined for all the attributes associated with a demand, the demand substitution allowances 140 are examined to determine which attribute substitutions are allowed for that particular demand. For example, the acceptable attribute substitution 150 may allow DB2 programming attribute to be substituted for a senior C++ programmer. For example, the 140 input data describes how, for a particular demand, it may be that substitution is not permitted on the job role attribute. Alternatively, 140 input data, for a particular demand may specify that a particular attribute (for example geography) does not constrain the set of acceptable substitutes, and any substitution is permitted.

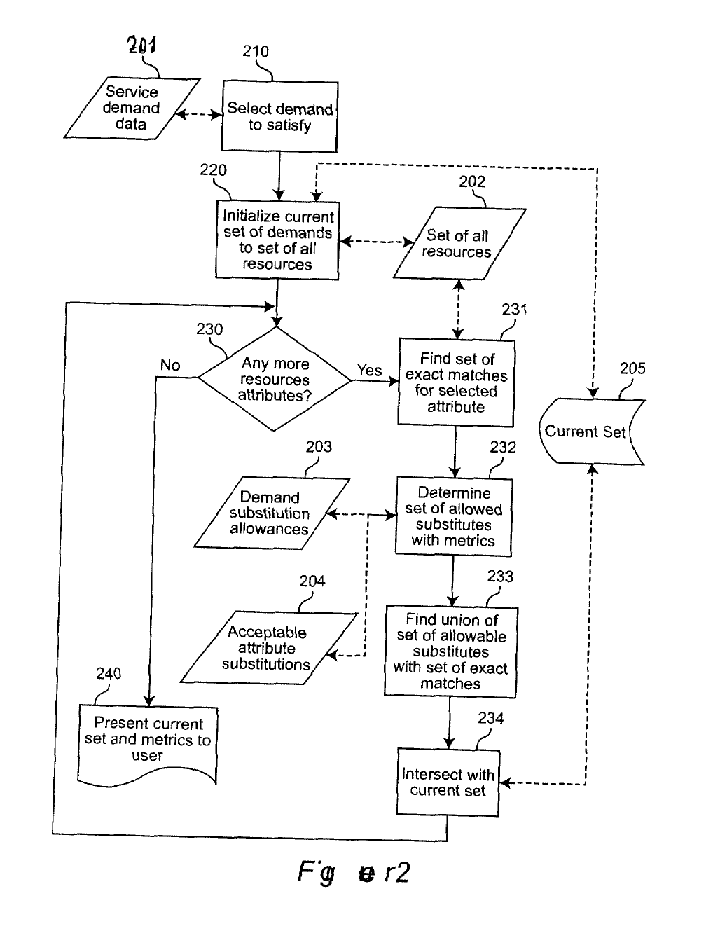

Allocation of resources for a service engagement must consider the availability of the human assets. The desired situation is when the ideal resource in terms of attributes is available for each engagement. However, this is rarely the case. As such, service organizations must compromise, or make allowances, for staffing engagements with the best available resource. Once the various inputs have been analyzed and the allowances and substitutions defined, the Employee Substitution for Service Engagement Method 100 creates an Employee Allocation Plan 160. This employee allocation plan 160 provides a ranked list of the available resources for each engagement demand. This ranked list is determined through a weighting of metrics and penalties associated with the various substitutions. The method for calculating these rankings and creating the employee allocation plan 160 is described by the flowchart of FIG. 2.

Data utilized by the method may be stored in a single database or distributed across numerous databases within the service organization network. Solid lines are used in FIG. 2 to represent the paths taken within the process. Data exchanged while performing the process is shown with dashed lines. As shown in FIG. 2, a service engagement is defined as a set of service demands and is provided to a computer which implements the method in the form of service demand data 201. The method selects a demand to be satisfied from the service demand data 201 at step 210. This selection can be done manually or can be implemented by the computer which chooses a demand from the set of demands according to some algorithm. This algorithm could be a simple as a first entry then next entry or some other process dependent on some weighting of the importance or priority of the demand. For example, let there be I resource demands Dᵢ, where i={0, . . . , I−1} (FIG. 2, data 201). The service demand data 201 will include the attribute data associated with each demand. A demand or supply resource can be described by any finite number of different resource attributes. Each resource attribute can take on categorical or numerical values. In addition, each demand, for each attribute, specifies matching criteria for that attribute. For a particular invocation of the procedure, it may decide that a particular attribute will not be matched, or that it may be matched by a set of allowable substitutes, in addition to the specified value. The substitutes may or may not have penalties associated with their use. An example of this type of attribute may be location. A demand may specify that for a particular service engagement, the demand must be satisfied by a resource located in a particular geography.

For example, let a resource Rᵢ be described by a set of K attributes aₖ, where k={0, 1, . . . , K−1}. Attributes are categorical, taking values from a finite set of possibilities. Let R be the set of all available resources. Each demand is associated with a resource request Rᵢ and Boolean variables Sᵢₖ and Mᵢₖ as demand substitution allowances 203. Boolean variable Mᵢₖ indicates whether attribute aᵢₖ is to be considered in determining possible resources to fill demand Dᵢ. If Mᵢₖ=0, then attribute aᵢₖ does not constrain the set of acceptable substitutes for demand Dᵢ. Boolean variable Sᵢₖ indicates whether substitution for attributes aᵢₖ is allowed for demand Dᵢ. If Sᵢₖ=0 and Mᵢₖ=1, then an exact match for demand Dᵢ is required. If Sᵢₖ=1 and Mᵢₖ=1, then either an exact match or a match from a list of acceptable substitutes T(aᵢₖ) from 204 is permissible.

Once the demand is selected, the method initializes the allocation of employees at step 220. This initialization accepts the set of all resources 202 data without regard to the suitability of the resource for the particular demand. This data can be stored in a database associated with the computer in which the method is implemented or can be stored in other database accessible through a network. Following the flowchart of FIG. 2, the set of possible resources for a particular demand is then determined through a process of culling the initial set through the use of Mᵢₖ and Sᵢₖ matching attributes at step 232. At the same time, a metric is associated with each allowable substitute, indicating how undesirable it is relative to a perfect match.

Here, the metric can be general. It can be a “cost” associated with a particular substitution (that is, using a Java programmer rather than a C++ programmer costs $10, while using a New Yorker when you requested a Californian costs $800. This may relate to for example, costs of retraining, or commuting, or to some qualitative decision on the “loss of quality” incurred by using a substitute. In this scheme you can simply add up the substitute costs to get a final metric for how far away you are from ideal. That is, if you substitute both geography and programmer type, you add up the two costs, so that's worse than substituting only one of them. Alternatively, a simple priority scheme could be used. Such as, if the only attribute which doesn't match is “geography”, then I would choose substitutes in the following preference order: NY, NJ, PA, etc.

At step 233, the penalty of the resource is updated with the penalty determined for the attribute. The process then checks to determine if all attributes have been considered at step 230. If all attributes have been considered, the new set of eligible resources and the associated metrics are provided to the user at step 240.

This method can also be defined by describing the algorithms associated with each step as provided below. The description appears in the flow in italics.

Do for each iε{0, . . . , I−1} for all demands (step 210). Consider all demands.
E=R initialize to set of all resources (step 220). Assume that any resource can satisfy a demand.
Do for each kε{0, . . . , K−1} for each attribute (step 230) This goes through the attributes one by one.
   a=aᵢₖ the current attribute
   if mᵢₖ=1 if matching is desired. That is, if the user cares whether this attribute matches the demand.
      A={R|_{aqk}=aᵢₖ} A is the set of all exact matches (step 231).
      Get all the resources which exactly match this attribute
      if sᵢₖ=1 if substitution is allowed
         X=T(a) X is the set of allowable substitutes for a (data 204)
         B={R|a_{qk}εX} set of available resources such that the k^{th} attribute is allowed (step 232) The method assigns the penalty associated with each substitute.
         C=A∪B C is the union of A with B (step 233). This is the set of allowable matches. The method updates the penalty already assigned to a given resource with the penalty contributed by the substitution for the current attribute.
      E=C∩E This is the new set of eligible resources
   If sᵢₖ=0 if substitution is not allowed
      E=A∩E the new set of eligible resources (step 234) which is simply the intersection of the current acceptable set with the set of exact matches

While the invention has been described for a preferred embodiment, those skilled in the art will recognize that the invention can be practiced with modification within the spirit and scope of the appended claims.

What we claim as new and desire to secure by Letters Patent is as follows:

1. A computer-implemented method for determining a set of acceptable resource supply entities for a given resource demand, the method comprising:
describing a demand as a set of attributes
describing a supply of human resources for said demand using said set of attributes,
defining substitution rules and penalties for said supply to satisfy each of said set of attributes other than that specifically identified for said demand,
finding a set of exact matches for each of said set of attributes from said supply,
applying said substitution rules and penalties for set of allowed substitutions
determining a set of allowed substitutions for said supply of resources for said demand,
creating metrics for said set of allowed substitutions, where said metrics describe a goodness for said substitution of said supply, and
providing said set of substitutions and matches for each of said set of attributes and said metrics for each of said set of allowed substitutions.

2. The method of claim 1 wherein said demand includes at least one of a set of attribute values for providing at least one of a group of existing service offerings, and wherein attributes include at least one of a group of descriptors to include but not limited to skills, experience, geographic location, cost, availability, etc., required for providing said at least one of said group of existing service offerings.

3. The method of claim 2 wherein said supply of human resources corresponds to said set of attribute values.

4. The method of claim 1 wherein said substitution rules and penalties identify which said each of said set of attributes are considered when determining said set of allowable substitutions.

5. The method of claim 1 wherein said metrics provide a rating for prioritizing acceptable substitutions for each of said set of attributes.

6. The method of claim 1 wherein said step of providing said set of substations and matches can be performed in the form of an electronic or printed listing.

7. A computerized system for determining a set of acceptable resource supply entities for a given resource demand, comprising:
at least one computer or network of computers into which is input a demand as a set of attributes that describe a supply of human resources for said demand using said set of attributes and substitution rules and penalties that constrain which said supply is allowed to satisfy each of said set of attributes other than that specifically identified for said demand; and
software operating on said computer or network of computers which is executed by said computer or network of computers,
said computer or network of computers finds a set of exact matches for each of said set of attributes from said supply, said computer or network of computers applies said substitution rules and penalties for a set of allowed substitutions,
said computer or network of computers determines a set of allowed substitutions for said supply of resources for said demand,
said computer or network of computers creates metrics for said set of allowed substitutions where said metrics describe a goodness for said substitution of said supply, and
said computer or network of computers provides said set of substitutions and matches for each of said set of attributes and said metrics for each of said set of allowed substitutions.

8. The computerized system of claim 7 wherein said at least one computer or network of computers defines said resource demand to include at least one of a set of attribute values for providing at least one of a group of existing service offerings, and wherein attributes include at least one of a group of descriptors to include but not limited to skills, experience, geographic location, cost, availability, etc., required for providing said at least one of said group of existing service offerings.

9. The computerized system of claim 7 wherein said at least one computer or network of computers utilizes said substitution rules and penalties to identify which said each of said set of attributes are considered when determining said set of allowable substitutions

10. The computerized system of claim 7 wherein said at least one computer or network of computers creates said metrics to provide a rating for prioritizing acceptable substitutions for each of said set of attributes.

11. A computer readable medium encoding a program for determining a set of acceptable resource supply entities for a given resource demand which executes the following steps:
describing a demand as a set of attributes
describing a supply of human resources for said demand using said set of attributes,
defining substitution rules and penalties for said supply to satisfy each of said set of attributes other than that specifically identified for said demand,
finding a set of exact matches for each of said set of attributes from said supply,
applying said substitution rules and penalties for set of allowed substitutions
determining a set of allowed substitutions for said supply of resources for said demand,
creating metrics for said set of allowed substitutions, where said metrics describe a goodness for said substitution of said supply, and
providing said set of substitutions and matches for each of said set of attributes and said metrics for each of said set of allowed substitutions.

12. The computer readable medium of claim 11 wherein a portion of said program used for determining a set of acceptable resource supply entities for a given resource demand defines said demand to include at least one of a set of attribute values for providing at least one of a group of existing service offerings, and wherein attributes include at least one of a group of descriptors to include but not limited to skills, experience, geographic location, cost, availability, etc., required for providing said at least one of said group of existing service offerings.

13. The computer readable medium of claim 11 wherein a portion of said program used for determining a set of acceptable resource supply entities for a given resource demand said utilizes substitution rules and penalties to identify which said each of said set of attributes are considered when determining said set of allowable substitutions

14. The computer readable medium of claim 11 wherein a portion of said program used for determining a set of acceptable resource supply entities for a given resource demand creates said metrics to provide a rating for prioritizing acceptable substitutions for each of said set of attributes.
